(19) United States
(12) Patent Application Publication
(10) Pub. No.: US 2015/0163772 A1
(43) Pub. Date: Jun. 11, 2015

(54) METHOD AND APPARATUS OF COMPRESSING A MULTI-CARRIER MODULATION SIGNAL IN FREQUENCY DOMAIN

(71) Applicant: Alcatel Lucent, Boulogne Billancourt (FR)

(72) Inventors: Wei Ni, Shanghai (CN); Zhaojun Xu, Shanghai (CN); Yanbo Tang, Shanghai (CN); Xiaobing Leng, Shanghai (CN); Gang Shen, Shanghai (CN); Yan Meng, Shanghai (CN)

(73) Assignee: Alcatel Lucent, Boulogne Billancourt (FR)

(21) Appl. No.: 14/412,527

(22) PCT Filed: Jun. 17, 2013
(86) PCT No.: PCT/IB2013/001514

§ 371 Date: Jan. 2, 2015

(30) Foreign Application Priority Data
Jul. 3, 2012 (CN) 201210228853.1

(51) Int. Cl. H04W 72/04; H04W 4/18; H04W 28/06

(52) U.S. Cl. CPC H04W 72/042; H04W 28/06; H04W 4/18; H04W 72/0453; H04W 88/085

(57) ABSTRACT

The invention provides a method and an apparatus, of compressing a multi-carrier modulation signal in frequency domain. By setting a modulation mode indicator, the preferable technical scheme could be changed dynamically according to the modulation mode, so as to select the corresponding bits for the different modulation mode. Moreover, according the preferable technical scheme of the present invention, the signal of the data channel in the resource element after extracting the second scale factor is represented by the bits which are occupied by a pair of I/Q signal. Thus, more bits are saved and compression ratio is enhanced.

### FIELD OF THE INVENTION

The present disclosure relates to mobile communication technology and particularly to a method and an apparatus of compressing a multi-carrier modulation signal in frequency domain.

### BACKGROUND OF THE INVENTION

With the hyper-growth of the mobile internet traffic, the traditional RAN becomes too expensive for mobile operators to keep competitive in the future. In order to reduce cost as well as to provide better services to customers, many mobile operators and vendors release various attractive solutions based on distributed antenna systems (DAS), such as CMCC's is Cloud-RAN (C-RAN), ALU's lightRadio, and so on. Due to the DAS-based RAN architecture, the requirement of eNB sites could be cut down largely and the base-band equipments could be shared among several virtual eNB. Compared with the traditional RAN, such architecture can save OPEX and CAPEX. Moreover, advanced scheduling and signal processing techniques, such as inter-cell interference cancelling (ICIC) and coordinated multi-point transmission (CoMP), can be implemented easily to enhance the user experience under such architecture.

However, in these DAS-based systems, the base band units (BBUs) and the remote radio heads (RRHs) are separated and interconnected with OBRI (Open BBU-RRH Interface) or CPRI (Common Public Radio Interface) for data transporting. Original time domain base band signals are transported on those wired connection. This architecture imposes great challenge on OBRI/CPRI bandwidth requirement. For example, the bandwidth requirement for 20 MHz LTE systems with 8Tx/8Rx antennas is up to 9.8304 Gbps. At the evolution phase of LTE-Advanced, this bandwidth requirement will be sharply expanded to 49.152 Gbps.

For the above problem of high bandwidth requirement, there is some algorithms used to compress the base band signal, for example, time domain signal compression algorithm used by Light Radio of Alcatel Lucent (shown in FIG. 1) and a compress algorithm of Samplify (shown in FIG. 2). These algorithms could provide 2×˜3× compression ratio with slight performance loss, thereby reduce the requirement of the bandwidth of the wired transportation. Compared with the transportation without compression, only less than half fiber resources are needed by using those effective compression algorithms.

However, for the multi-carrier modulation signal in a wireless communication system, such as OFDM or DFT-S-OFDM modulation is adopted in LTE/LTE-A system, it is more effectively to conduct the compression in frequency domain. With the compression algorithm aiming at the features of the received uplink multi-carrier modulation signal, a higher compression ratio could be achieved.

In another prior art technical scheme, a method of extracting a common scale factor in group to conduct compression in frequency domain. In the scheme, set a symbol and 12 subcarriers corresponding to that symbol in a physical resource block is set as a group, and a common scale factor for this group is extracted. This means, for a physical resource block pair, 14 groups will be set and 14 common scale factors will be extracted. Thus, it is complicated and this scheme has not utilized the feature that the modulation mode in the resource elements occupied by the data channel in one physical resource block pair is identical.

Furthermore, the quantification mode in this scheme is fixed and could not change the quantification mode with the change of the channel quality (i.e., with the change of the modulation mode). Therefore, for I/Q signal in the resource elements occupied by the data channel in the physical resource block pair, due to the consideration of the possible modulation mode, for example, QPSK, 16 QAM and 64 QAM, the scheme will generally quantify the I/Q signal in the resource element by using 8 bits (i.e., quantify the I signal by using 4 bits and quantify the Q signal by using 4 bits) in order to fulfill the requirement of 64 QAM. For example, when the I/Q signal after extracting the common scale factor is 1+3i, the scheme will use 8 bits 0001, 0011 to quantify I signal and Q signal respectively. However, it is apparent that although this scheme could fulfill the requirement of 64 QAM, this kind of quantification mode will cause many resources wasted for the data channel modulated with QPSK and 16 QAM. Further, for 64 QAM, the efficiency of this kind of quantification mode, in which 4 bits are for I signal and 4 bits are for Q signal, is very low, since 4 bits allocated to every signal could represent 16 possibilities, but in fact I signal and Q signal in 64 QAM modulation is mode only has 8 possibilities (i.e. −7, −5, −3, −1, 1, 3, 5, 7).

On the other hand, in the real application, the percentage of QPSK and 16 QAM is higher (for example, at least 50% is QPSK), which makes the quantification mode in this prior art scheme occupy a lot unnecessary resources.

### SUMMARY OF THE INVENTION

Thus, the prior art scheme mentioned in the background could not change the quantification mode used for I/Q signal in the resource element with the change of the channel quality. Meanwhile, for 64 QAM, the efficiency of this kind of quantification mode is also low, thereby causing the lower compression ratio in the exiting schemes.

Thus in view of the problem present in the prior art, according to a first aspect of the invention, a method, in a base band unit, of compressing a multi-carrier modulation signal in frequency domain is provided, wherein the method is implemented in terms of a physical resource block pair, the method comprises the following steps: A. setting a control channel position indicator including a first number of bits, for indicating symbol position occupied by the control channel in the physical resource block pair; B. setting a modulation mode indicator including a second number of bits, for indicating modulation mode of data channel in the physical resource block; C. extracting a first common scale factor of signals of the control channel in the physical resource block, and quantifying the first common scale factor; D. extracting a second common scale factor of signals of the data channel in the physical resource block, and quantifying the second common scale factor; E. configuring the control channel position indicator, the modulation mode indicator, the quantified first common scale factor and the quantified second common scale factor to a signal header; F. for each resource element in the physical resource pair occupied by the signal of the control channel, representing the signal of the control channel in the is resource element after extracting the first common scale factor with a third number of bits, and for each resource element in the physical resource pair occupied by the signal of the data channel, representing the signal of the data channel in the resource element after extracting the second scale factor with a fourth number of bits, according to the modulation mode of the data channel in the physical resource block pair; G. encapsulating the signal header, the signal of the control channel in the resource element in the physical resource block pair processed through the step F, and the signal of the data channel in the resource element in the physical resource block pair processed through the step F into a compressed package; and H. sending the compressed package to a remote radio head.

According to an embodiment of the present invention, the first number of bits is 2 bits, when the number of resource blocks in the downlink bandwidth is greater than 10.

According to an embodiment of the present invention, the first number of bits is 3 bits, when the number of resource blocks in the downlink bandwidth is less than or equal to 10.

According to an embodiment of the present invention, the second number of bits is 2 bits, and the modulation mode of data channel includes QPSK, 16 QAM and 64 QAM.

According to an embodiment of the present invention, the first common scale factor and/or the second common scale factor are quantified by using full-resolution 16 bits.

According to an embodiment of the present invention, the step F further includes: F1. for each resource element in the physical resource pair occupied by the signal of the control channel, representing the signal of the control channel in the resource element after extracting the first common scale factor with 2 bits; and F2. for each resource element in the physical resource pair occupied by the signal of the data channel, representing the signal of the data channel in the resource element after is extracting the second scale factor with the number of bits which are occupied by a pair of I/Q signal in the modulation mode of the data channel in the physical resource block pair.

According to a second aspect of the invention, a method, in a remote radio head, of decompressing a multi-carrier modulation signal in frequency domain is provided, wherein the method is implemented in terms of a physical resource block pair, the method comprises the following steps: a. receiving a compressed package from a base band unit, wherein the compressed package includes a signal header and multiple bits, the multiple bits including bits representing the signal of the control channel after extracting a first common scale factor and bits representing the signal of the data channel after extracting a second common scale factor, and the signal header including a control channel position indicator, a modulation mode indicator, a quantified first common scale factor and a quantified second scale factor, wherein the control channel position indicator includes a first number of bits, for indicating symbol position occupied by the control channel in the physical resource block pair, and the modulation mode indicator includes a second number of bits, for indicating modulation mode of data channel in the physical resource block; b. recovering the quantified first common scale factor and the quantified second scale factor to the first common scale factor and the second common scale factor respectively; c. determining the bits representing the signal of the control channel after extracting the first common scale factor and the bits representing the signal of the data channel after extracting the second common scale factor in the multiple bits according to the control channel indicator, and transforming the bits representing the signal of the control channel after extracting the first common scale factor to the signal of the control channel after extracting the first common scale factor based on a third number of bits, wherein for each resource element in the physical resource pair occupied by the signal of the control channel, the third is number of bits represent the signal of the control channel in the resource element after extracting the first common scale factor; d. determining a fourth number of bits according to the modulation mode indicator, and transforming the bits representing the signal of the data channel after extracting the second common scale factor to the signal of the data channel after extracting the second common scale factor based on the fourth number of bits, wherein for each resource element in the physical resource pair occupied by the signal of the data channel, the fourth number of bits represent the signal of the data channel in the resource element after extracting the second common scale factor; e. recovering the signal of the control channel after extracting the first common scale factor by using the first common scale factor, and recovering the signal of the data channel after extracting the second common scale factor by using the second common scale factor; and f. processing the recovered signal of the control channel and the recovered signal of the data channel with IFFT.

According to a third aspect of the invention, an apparatus, in a base band unit, of compressing a multi-carrier modulation signal in frequency domain is provided, the apparatus comprises: a first setting unit, for setting a control channel position indicator including a first number of bits, for indicating symbol position occupied by the control channel in the physical resource block pair; a second setting unit, for setting a modulation mode indicator including a second number of bits, for indicating modulation mode of data channel in the physical resource block; a first extracting and quantifying unit, for extracting a first common scale factor of signals of the control channel in the physical resource block, and quantifying the first common scale factor; a second extracting and quantifying unit, for extracting a second common scale factor of signals of the data channel in the physical resource block, and quantifying the second common scale factor; a configuring unit, for configuring the control channel position indicator, the modulation mode is indicator, the quantified first common scale factor and the quantified second common scale factor to a signal header; a representing unit, for for each resource element in the physical resource pair occupied by the signal of the control channel, representing the signal of the control channel in the resource element after extracting the first common scale factor with a third number of bits, and for each resource element in the physical resource pair occupied by the signal of the data channel, representing the signal of the data channel in the resource element after extracting the second scale factor with a fourth number of bits, according to the modulation mode of the data channel in the physical resource block pair; an encapsulating unit, for encapsulating the signal header, the signal of the control channel in the resource element in the physical resource block pair processed by the representing unit, and the signal of the data channel in the resource element in the physical resource block pair processed by the representing unit into a compressed package; and a sending unit, for sending the compressed package to a remote radio head.

According to a fourth aspect of the invention, an apparatus, in a remote radio head, of decompressing a multi-carrier modulation signal in frequency domain is provided, the apparatus comprises: a receiving unit, for receiving a compressed package from a base band unit, wherein the compressed package includes a signal header and multiple bits, the multiple bits including bits representing the signal of the control channel after extracting a first common scale factor and bits representing the signal of the data channel after extracting a second common scale factor, and the signal header including a control channel position indicator, a modulation mode indicator, a quantified first common scale factor and a quantified second scale factor, wherein the control channel position indicator includes a first number of bits, for indicating symbol position occupied by the control channel in the physical resource block pair, and the modulation mode indicator includes a second number of bits, for is indicating modulation mode of data channel in the physical resource block; a first recovering unit, for recovering the quantified first common scale factor and the quantified second scale factor to the first common scale factor and the second common scale factor respectively; a first transforming unit, for determining the bits representing the signal of the control channel after extracting the first common scale factor and the bits representing the signal of the data channel after extracting the second common scale factor in the multiple bits according to the control channel indicator, and transforming the bits representing the signal of the control channel after extracting the first common scale factor to the signal of the control channel after extracting the first common scale factor based on a third number of bits, wherein for each resource element in the physical resource pair occupied by the signal of the control channel, the third number of bits represent the signal of the control channel in the resource element after extracting the first common scale factor; a second transforming unit, for determining a fourth number of bits according to the modulation mode indicator, and transforming the bits representing the signal of the data channel after extracting the second common scale factor to the signal of the data channel after extracting the second common scale factor based on the fourth number of bits, wherein for each resource element in the physical resource pair occupied by the signal of the data channel, the fourth number of bits represent the signal of the data channel in the resource element after extracting the second common scale factor; a second recovering unit, for recovering the signal of the control channel after extracting the first common scale factor by using the first common scale factor, and recovering the signal of the data channel after extracting the second common scale factor by using the second common scale factor; and a processing unit, for processing the recovered signal of the control channel and the recovered signal of the data channel with IFFT.

Since the modulation mode in the data channel in a physical resource is block pair is identical, the common factor extracted from the signals in each resource element occupied by the data channel is also identical.

With the preferable technical solution of the present invention, the above feature could be utilized, thereby the compression of the multi-carrier modulation signal is implemented in frequency domain in terms of a physical resource block pair. Further, by setting a modulation mode indicator, the preferable technical scheme could be changed dynamically according to the modulation mode, so as to select the corresponding bits for the different modulation mode.

Moreover, according to the preferable technical scheme of the present invention, the signal of the data channel in the resource element after extracting the second scale factor is represented by the bits which are occupied by a pair of I/Q signal. Compared to the quantification mode used for I signal and Q signal respectively in the prior art, more bits are saved and compression ratio is enhanced.

Thus, the present invention accomplishes a better compression ratio for the multi-carrier modulation signal sent from BBU to RRH. Therefore, the bandwidth requirement of OTN between BBU and RRH is reduced, thereby transporting the signals on OTN more effectively. Further, the present invention could be easily accomplished and reduce the cost to build backhaul for the DAS-based RAN.

### BRIEF DESCRIPTION OF DRAWINGS

Other features, objects and advantages of the invention will become more apparent upon review of the following detailed description of non-limiting embodiments taken with reference to the drawings in which:

FIG. 1 illustrates a schematic diagram of time domain signal compression in Light Radio in the prior art;

FIG. 2 illustrates a schematic diagram of compression of Samplify in the prior art;

FIG. 3 illustrates a method flowchart of compressing a multi-carrier is modulation signal in frequency domain in a base band unit according to an embodiment of the invention;

FIG. 4 illustrates a schematic diagram of a physical resource block pair according to an embodiment of the invention;

FIG. 5 illustrates a schematic diagram of encapsulating a compressed package according to an embodiment of the invention;

FIG. 6 illustrates a method flowchart of decompressing a multi-carrier modulation signal in frequency domain in a remote radio head according to an embodiment of the invention; and

FIG. 7 illustrates a schematic diagram of a system of compressing a multi-carrier modulation signal in frequency domain according to an embodiment of the invention.

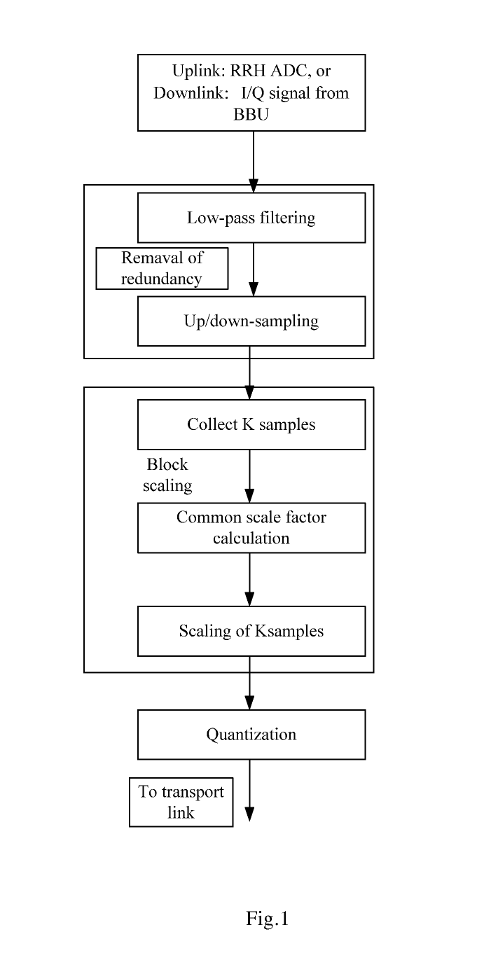

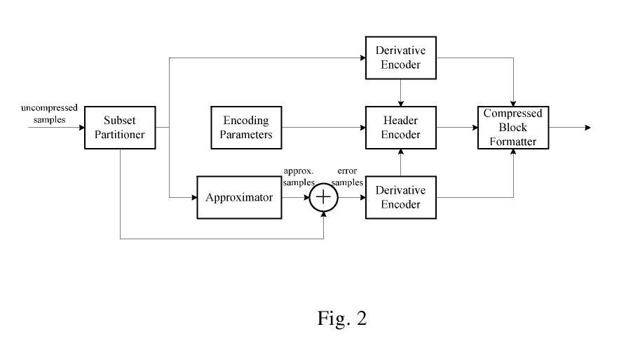

Identical or like reference numerals denote identical or like components or features throughout the different figures in the drawings.

### DETAILED DESCRIPTION OF EMBODIMENTS

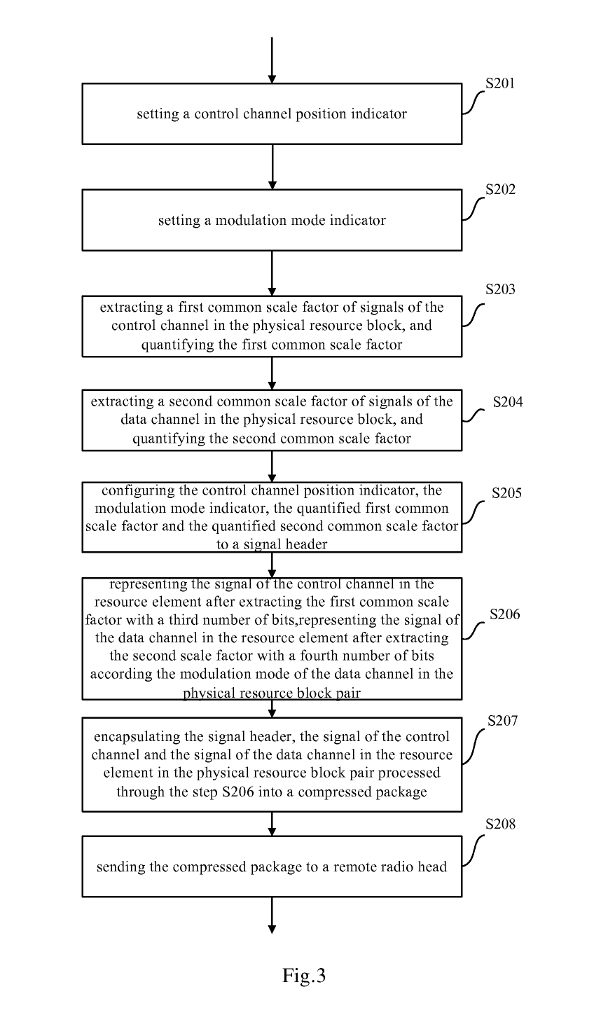

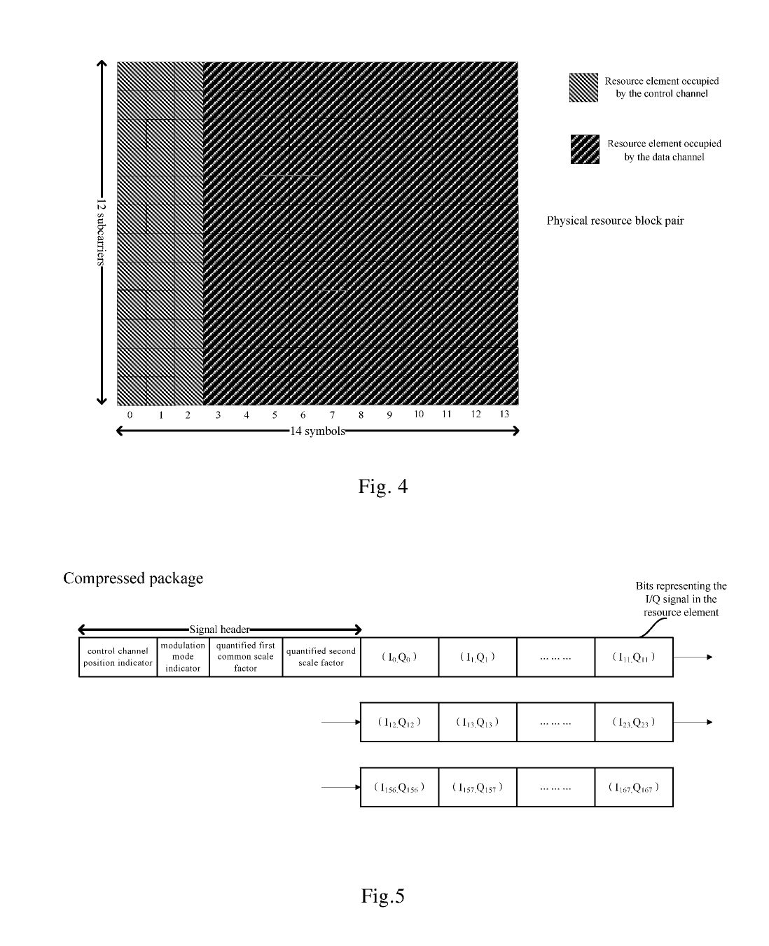

FIG. 3 illustrates a method flowchart of compressing a multi-carrier modulation signal in frequency domain in a base band unit according to an embodiment of the invention. FIG. 4 illustrates a schematic diagram of a physical resource block pair according to an embodiment of the invention. FIG. 5 illustrates a schematic diagram of encapsulating a compressed package according to an embodiment of the invention. The flowchart will be described with reference to FIGS. 4-5.

As shown in FIG. 3, in step S201, a control channel position indicator is set for indicating symbol position occupied by the control channel in the physical resource block pair (as shown in FIG. 4). (FIG. 4 shows the situation where the control channel occupies symbol 0 to symbol 2.)

When the number of resources blocks in the downlink bandwidth N^{DL}_{RB}>10, there are four possibilities of the OFDM symbol for the control channel, i.e. no symbol, using symbol 0, using symbols 0 and 1, using symbols 0 to 2.

In this case, 2 bits could be allocated for the control channel position indicator to distinguish the above four possibilities. Table 1 shows an allocation mode, for example.

TABLE 1

control channel position indicator

| | 00 | 01 | 10 | 11 |
|---|---|---|---|---|
| OFDM symbol | no | symbol | symbols | symbols |
| for the control | symbol | 0 | 0 and 1 | 0 to 2 |
| channel | | | | |

In table 1, four kinds of 2 bits, 00, 01, 10, 11 are used respectively to represent four kinds of OFDM symbol for the control channel when the number of resources blocks in the downlink bandwidth N^{DL}_{RB}>10. 00 corresponds to the situation of no symbol, 01 corresponds to the situation of symbol 0, 10 corresponds to the situation of symbols 0 to 1, and 11 corresponds to the situation of symbols 0 to 2. For the situation corresponding to FIG. 4, the control channel position indicator is 11. It should be noted that the above allocation mode for the corresponding bits is only exemplary, not limited. Those skilled in the art could use other suitable corresponding relationship.

When the number of resources blocks in the downlink bandwidth N^{DL}_{RB}≦10, there are five possibilities of the OFDM symbol for the control channel, i.e. no symbol, using symbol 0, using symbols 0 and 1, using symbols 0 to 2, using symbols 0-3.

In this case, 3 bits could be allocated for the control channel position indicator to distinguish the above five possibilities. Table 2 shows an allocation mode, for example.

TABLE 2

| | control channel position indicator | | | | |
|---|---|---|---|---|---|
| | 000 | 001 | 010 | 011 | 100 |
| OFDM symbol | no | symbol | symbols | symbols | symbols |
| for the control | symbol | 0 | 0 and 1 | 0 to 2 | 0 to 3 |
| channel | | | | | |

In table 2, five kinds of 3 bits, 000, 001, 010, 011, 100 are used respectively to represent five kinds of OFDM symbol for the control is channel when the number of resources blocks in the downlink bandwidth N^{DL}_{RB}≦10. 000 corresponds to the situation of no symbol, 001 corresponds to the situation of symbol 0, 010 corresponds to the situation of symbols 0 to 1, 011 corresponds to the situation of symbols 0 to 2 and 100 corresponds to the situation of symbols 0 to 2. For the situation corresponding to FIG. 4, the control channel position indicator is 011. It should be noted that the above allocation mode for the corresponding bits is only exemplary, not limited. Those skilled in the art could use other suitable corresponding relationship.

Further, since the present narrow band system, i.e. the situation of N^{DL}_{RB}≦10 is relative less, for distinguishing and locating the symbol position the related control channel occupies, 2 bits could be allocated for the control channel position indicator in general.

As discussed above, advantageously, according to the number of the resource blocks in the downlink bandwidth, 2 bits or 3 bits could be set for the control channel position indicator in order to indicate the symbol position the control channel occupies in a physical resource block.

Then, in step S202, a modulation mode indicator is set for indicating modulation mode of data channel in the physical resource block. According to the channel quality, there are three modulation modes now, QPSK, 16 QAM and 64 QAM. Thus, a modulation mode indicator occupying 2 bits could be set to distinguish the above three modulation is modes. In another aspect, by setting the modulation mode indicator, the compression strategy could be flexible and dynamically changed, and thus the compression ratio is raised. For the control channel, as it will use QPSK modulation mode fixedly, there is no need to set an indicator for the control channel. Table 3 shows a mode for setting the modulation mode indicator, for example.

TABLE 3

| | modulation mode indicator | | |
|---|---|---|---|
| | 00 | 01 | 10 |
| Modulation mode | QPSK | 16QAM | 64QAM |

In table 3, three kinds of 2 bits, 00, 01, 10 are used respectively to represent the modulation mode for the data channel. 00 corresponds to QPSK, 01 corresponds to 16 QAM and 10 corresponds to 64 QAM. Similarly, it should be noted the above corresponding bit is only exemplary, but not limited. Those skilled in the art could use other suitable corresponding relationship.

Then, in step S203, a first common scale factor of signals of the control channel in the physical resource block is extracted and quantified. Since control signals in the physical resource block pair all use QPSK modulation mode, an identical common scale factor could be extracted from the signals in each resource element occupied by the control channel (small squares with slashes towards right in FIG. 4). For example, with reference to FIG. 4, in this case, the common scale factor will be extracted from the transporting signals in the resource elements in three columns from the left. Further, this common scale factor could be quantified by using full-resolution (for example, 16 bits). Through this step, the real part (I signal) and the imaginary part (Q signal) of a subcarrier after extracting the common scale factor is a very small integer.

In step 204, a second common scale factor of signals of the data is channel in the physical resource block is extracted an quantified. Since the modulation mode adopted by the data channel in one physical resource block pair is identical, an identical common scale factor could be extracted from the signals in each resource element occupied by the data channel (small squares with slashes towards left in FIG. 4). For example, with reference to FIG. 4, in this case, the common scale factor will be extracted from the transporting signals in the resource elements from the fourth column from the left to the last column. For example, if the modulation mode is 16 QAM, the extracted common scale factor is 1623, i.e. all the subcarrier would be divided by 1623. The real part (I signal) and the imaginary part (Q signal) of a subcarrier after extracting the common scale factor is a very small integer.

Through step S203 and S204, the compression method of the present invention is implemented in terms of a physical resource block pair.

In step S205, the control channel position indicator, the modulation mode indicator, the quantified first common scale factor and the quantified second common scale factor are configured to a signal header, as shown in FIG. 5.

In step 206, for each resource element in the physical resource pair occupied by the signal of the control channel, the signal of the control channel in the resource element after extracting the first common scale factor is represented with a third number of bits, and for each resource element in the physical resource pair occupied by the signal of the data channel, the signal of the data channel in the resource element after extracting the second scale factor is represented with a fourth number of bits, according to the modulation mode of the data channel in the physical resource block pair.

Specifically, the bit allocation mode as shown in table 4 will be applied.

TABLE 4

| Modulation mode | QPSK | 16QAM | 64QAM |
|---|---|---|---|
| Bit allocation | 2 bits | 4 bits | 6 bits |

As shown in FIG. 4, the signal in the resource element after extracting is the scale factor is represented with the number of bits which are occupied by a pair of I/Q signal in the modulation mode. For example, when the modulation mode is QPSK, the signal in the resource element after extracting the scale factor is represented with 2 bits. The 2 bits is the number of bits which are occupied by a pair of I/Q signal. Since in the QPSK modulation mode, the signal in the resource element after extracting the scale factor has four possibilities, 1+1i, 1−1i, −1+1i and −1−1i, 2 bits could be utilized to distinguish the above four possibilities.

Herein, it should be noted, in the QPSK modulation mode, the above form of the signal after extracting the common scale factor is only exemplary, not limited. It is appreciated for those skilled in the art, the signal after extracting the common scale factor could be different according to the value of the common scale factor. For example, in the QPSK modulation mode, the signal after extracting the common scale factor in the resource element could also have these four possibilities, 1/\sqrt{2}+1/\sqrt{2}i, 1/\sqrt{2}−1/\sqrt{2}i, −1/\sqrt{2}+1/\sqrt{2}i, −1/\sqrt{2}−1/\sqrt{2}i.

Similarly, it should be understood that, for other modulation mode, for example, 16 QAM, 64 QAM, the form of the signal after extracting the common scale factor in the context is also only exemplary, not limited.

For 16 QAM modulation mode, the signal of the data channel after extracting the common scale factor in the resource element has 16 possibilities, for example, 1+1i, 1+3i, 1−1i, 1−3i, 3+1i, 3+3i, 3−1i, 3−1i, −3+1i, −3+3i, −3−1i, −3−3i, −1+1i, −1+3i, −1−3i and −1−1i. Thus, four bits could be utilized to represent the 16 possibilities. Similarly, for 64 QAM, 6 bits could be utilized to represent 64 possibilities for the signal of the data channel after extracting the common scale factor is in the resource element in the 64 QAM modulation mode.

Thus, on the contrary to the prior art, in the present invention, the quantization process has not been conducted separately for I signal and Q signal, instead, a pair of I/Q signal corresponds to bit. Table 5 shows the corresponding relationship in the situation of 16 QAM, for example.

TABLE 5
16QAM

| | |
|---|---|
| 1 + 1i | 0000 |
| 1 + 3i | 0001 |
| 1 − 1i | 0010 |
| 1 − 3i | 0011 |
| 3 + 1i | 0100 |
| 3 + 3i | 0101 |
| 3 − 3i | 0110 |
| 3 − 1i | 0111 |
| −1 + 1i | 1000 |
| −1 + 3i | 1001 |
| −1 − 3i | 1010 |
| −1 − 1i | 1011 |
| −3 + 1i | 1100 |
| −3 + 3i | 1101 |
| −3 − 1i | 1110 |
| −3 − 3i | 1111 |

For simplicity, each pair of I/Q signal has been extracted common scale factor at first in table 5. However, it has no limitation for the application of the present invention. Without the extraction of the common scale factor for each pair of I/Q signal, a corresponding relationship as describe in table 5 also exists. With reference to table 5, in the situation of 16 QAM, if the signal of the data channel after extracting the second common factor in a resource element is 1−1i, 0010 could be used to represent the signal of the data channel. If the signal of the data channel after extracting the second common factor in a resource element is 1−3i, 0011 could be used to represent the signal of the data channel.

It should be noted that, the above bit corresponding relationship is only exemplary, but not limited. Those skilled in the art could also use is other suitable corresponding relationship, for example, 0000 corresponding to 1+3i, and 0001 corresponding to 1+1i.

In the real application, for example, the modulation mode indicator could be set, according to the channel quality, for example, the suitable modulation mode of the data channel resulted from CQI. Then, the process for the signal in each resource element occupied by the data channel could be accomplished according to the modulation mode indicator.

In the other hand, since QPSK will always be used for the modulation of the control channel, for each resource element occupied by the signals of the control channel in the physical resource block pair, the signal after extracting the first common scale factor in the resource element would be always represented with 2 bits. For example, if the signal of the control channel after extracting the first scale factor is 1+1i, bits 00 could be used to represent it, for example.

In step S207, the signal header, the signal of the control channel and the signal of the data channel in the resource element in the physical resource block pair processed through the step S206 are encapsulated into a compressed package, as shown in FIG. 5.

With reference to FIG. 5, (I₀,Q₀), (I₁,Q₁) . . . (I₁₆₇,Q₁₆₇) are bits representing the signal after extracting the common scale factor in each resource element in the physical resource block pair respectively. Specifically, as shown in FIG. 4, in the case that the control channel occupies 0-2 symbols, (I₀,Q₀) . . . (I₃₅,Q₃₅) are is bits representing the signal of the control channel after extracting the first common scale factor, (I₃₆,Q₃₆) . . . (I₁₆₇,Q₁₆₇) are bits representing the signal of the data channel after extracting the second common scale factor. Since QPSK modulation mode is applied fixedly for the signal of the control channel, (I₀,Q₀) . . . (I₃₅,Q₃₅) will respectively occupy 2 bits in order to represent the signal of the control channel after extracting the first common scale factor in each resource element. When 16 QAM modulation mode is applied for the signal of the data channel, (I₃₆,Q₃₆) . . . (I₁₆₇,Q₁₆₇) will respectively occupy 4 bits in order to represent the signal of the data channel after extracting the second common scale factor in each resource element.

In step S208, BBU will send the compressed package (as shown in FIG. 5) to a RRH.

It is appreciated for those skilled in the art that the sequence of certain steps in the above steps could be switched, or some certain steps could be conduct at the same time. For example, the sequence of steps S201, S202 could be switched, or they could be conduct at the same time.

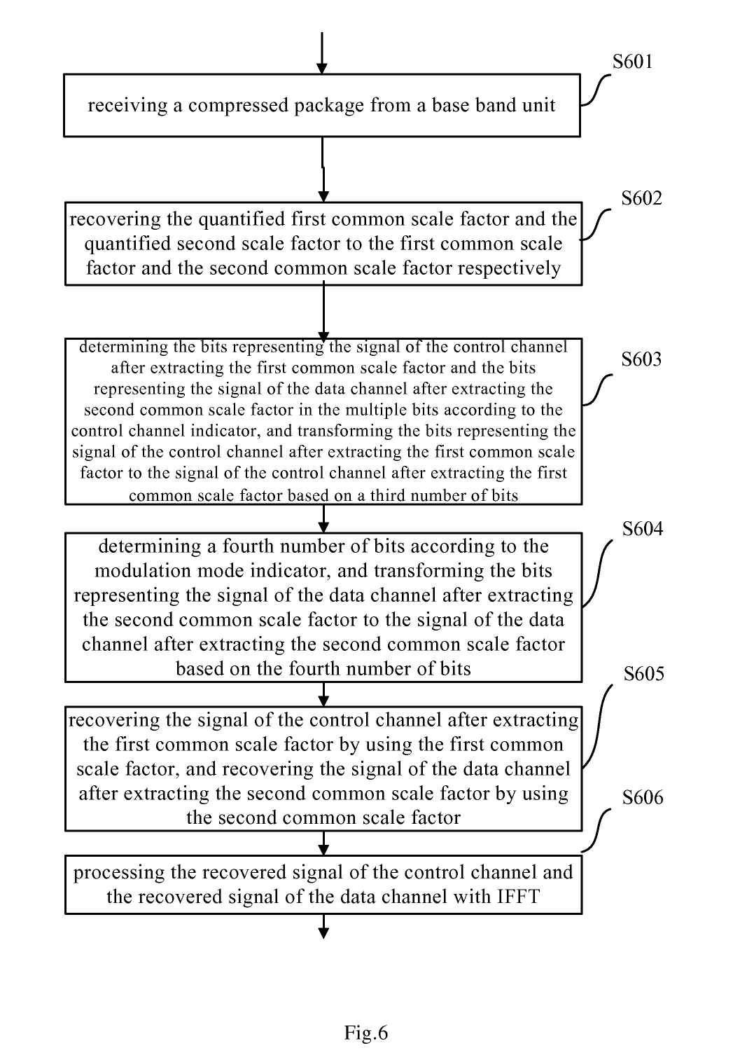

FIG. 6 illustrates a method flowchart of decompressing a multi-carrier modulation signal in frequency domain in a remote radio head according to an embodiment of the invention.

As shown in FIG. 6, in step 601, the RRH receives a compressed package (as shown in FIG. 5) from the BBU. Specifically, the compressed package includes a signal header and multiple bits. The multiple bits include bits representing the signal of the control channel after extracting a first common scale factor and bits representing the signal of the data channel after extracting a second common scale factor. Moreover, the signal header includes a control channel position indicator, a modulation mode indicator, a quantified first common scale factor and a quantified second scale factor, wherein the control channel position is indicator includes a first number of bits, for indicating symbol position occupied by the control channel in the physical resource block pair, and the modulation mode indicator includes a second number of bits, for indicating modulation mode of data channel in the physical resource block. In this step, the RRH could analyze the signal header at first, so as to conduct the following steps.

For the control channel position indicator, the details thereof has been introduced in the context related to the BBU, thus it will not be discussed in detail here. Similarly, for the modulation mode indicator, the details thereof has also been introduced in the context related to the BBU, thus it will not be discussed in detail here, either.

Then, in step S602, the quantified first common scale factor and the quantified second scale factor are recovered to the first common scale factor and the second common scale factor respectively. Specifically, these two common scale factors have been quantified by using full-resolution (for example, 16 bits). In this step, these two common scale factors will be recovered.

In step S603, the bits representing the signal of the control channel after extracting the first common scale factor and the bits representing the signal of the data channel after extracting the second common scale factor in the multiple bits are determined according to the control channel indicator, and the bits representing the signal of the control channel after extracting the first common scale factor are transformed to the signal of the control channel after extracting the first common scale factor based on a third number of bits.

Specifically, when the number of resource blocks in the downlink bandwidth N^{DL}_{RB}>10, and the bits of the control channel indicator is 11 (i.e. the control channel occupies symbol 0-2, with reference to table 1), (I₀,Q₀) . . . (I₃₅,Q₃₅) in FIG. 5 are then determined as the bits representing the signal of the control channel after extracting the first common scale factor, and (I₃₆,Q₃₆) . . . (I₁₆₇,Q₁₆₇) are determined is as the bits representing the signal of the data channel after extracting the second common scale factor in the multiple bits.

Since the modulation mode of the signal of the control channel is QPSK fixedly, each of(I₀,Q₀) . . . (I₃₅,Q₃₅)will use 2 bits. Therefore, in the RRH, for each of (I₀,Q₀) . . . (I₃₅,Q₃₅), with reference to the corresponding relationship between a pair of I/Q signal and bits under the QPSK modulation mode, every two bits will be transformed to a pair of I/Q signal after extracting a first common scale factor. This corresponding relationship is identical as the corresponding relationship used at the BBU side. For example, this corresponding relationship could be predefined between the BBU and the RRH.

Through this step, the bits representing the signal of the control channel after extracting the first common scale factor could be all transformed to the corresponding signal of the control channel after extracting the first common scale factor. For example, if the bits at (I₀,Q₀) is 00, 00 could be transformed to 1+1i.

In step S604, a fourth number of bits are determined according to the modulation mode indicator, and the bits representing the signal of the data channel after extracting the second common scale factor are transformed to the signal of the data channel after extracting the second common scale factor based on the fourth number of bits.

Specifically, assuming that in step S603 (I₃₆,Q₃₆) . . . (I₁₆₇,Q167) are determined as the bits representing the signal of the data channel after extracting the second common scale factor, and if the modulation mode indicator is 01 (with reference to table 3, i.e. the modulation mode is 16 QAM), the RRH knows each of (I₃₆,Q₃₆) . . . (I₁₆₇,Q₁₆₇) will use 4 bits, as shown in table 4. Therefore, in the RRH, for each of (I₃₆,Q₃₆) . . . (I₁₆₇,Q₁₆₇), with reference to the corresponding relationship between a pair of I/Q signal and bits under the 16 QAM modulation mode (as shown in table 5), every is four bits will be transformed to a pair of I/Q signal after extracting a second common scale factor. This corresponding relationship is identical as the corresponding relationship used at the BBU side. For example, this corresponding relationship could be predefined between the BBU and the RRH. Specifically, if the bits at (I₃₆,Q₃₆) is 0000, 0000 could be transformed to 1+1i.

In step S605, the signal of the control channel after extracting the first common scale factor is recovered by using the first common scale factor, and the signal of the data channel after extracting the second common scale factor is recovered by using the second common scale factor. Specifically, for example, after determining the signal of the control channel after extracting the first common scale factor represented by (I₀,Q₀) . . . (I₃₅,Q₃₅)in FIG. 5 and the signal of the data channel after extracting the second common scale factor represented by (I₃₆,Q₃₆) . . . (I₁₆₇,Q₁₆₇) in FIG. 5, the first common scale factor could be used to multiply each of the signal of the control channel after extracting the first common scale factor, and the second common scale factor could be used to multiply each of the signal of the data channel after extracting the second common scale factor, in order to recover the signal of the control channel and the signal of the data channel.

In step S606, the recovered signal of the control channel and the recovered signal of the data channel will be processed with IFFT, thus transforming the signal to time domain and thereby transporting the signal to the corresponding antenna port.

It is appreciated for those skilled in the art that the sequence of certain steps in the above steps could be switched, or some certain steps could be conduct at the same time. For example, steps S603, S604 could be conduct at the same time.

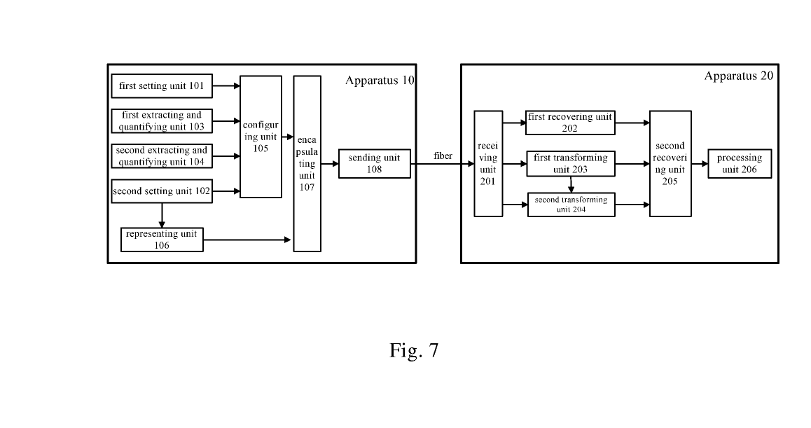

FIG. 7 illustrates a schematic diagram of a system of compressing a multi-carrier modulation signal in frequency domain according to an embodiment of the invention. The apparatus 10 is in the BBU, and the is apparatus 20 is in the RRH. Those two apparatuses are connected via fiber, and the apparatus 20 could be further connected to the antenna ports (not shown).

The apparatus 10 comprises:

a first setting unit 101, for setting a control channel position indicator including a first number of bits, for indicating symbol position occupied by the control channel in the physical resource block pair;

a second setting unit 102, for setting a modulation mode indicator including a second number of bits, for indicating modulation mode of data channel in the physical resource block;

a first extracting and quantifying unit 103, for extracting a first common scale factor of signals of the control channel in the physical resource block, and quantifying the first common scale factor;

a second extracting and quantifying unit 104, for extracting a second common scale factor of signals of the data channel in the physical resource block, and quantifying the second common scale factor;

a configuring unit 105, for configuring the control channel position indicator, the modulation mode indicator, the quantified first common scale factor and the quantified second common scale factor to a signal header;

a representing unit 106, for for each resource element in the physical resource pair occupied by the signal of the control channel, representing the signal of the control channel in the resource element after extracting the first common scale factor with a third number of bits, and for each resource element in the physical resource pair occupied by the signal of the data channel, representing the signal of the data channel in the resource element after extracting the second scale factor with a fourth number of bits, according to the modulation mode of the data channel in the physical resource block pair;

an encapsulating unit 107, for encapsulating the signal header, the signal of the control channel in the resource element in the physical is resource block pair processed by the representing unit, and the signal of the data channel in the resource element in the physical resource block pair processed by the representing unit into a compressed package; and a sending unit 108, for sending the compressed package to a remote radio head.

The apparatus 20 comprises:

a receiving unit 201, for receiving a compressed package from a base band unit, wherein the compressed package includes a signal header and multiple bits, the multiple bits including bits representing the signal of the control channel after extracting a first common scale factor and bits representing the signal of the data channel after extracting a second common scale factor, and the signal header including a control channel position indicator, a modulation mode indicator, a quantified first common scale factor and a quantified second scale factor, wherein the control channel position indicator includes a first number of bits, for indicating symbol position occupied by the control channel in the physical resource block pair, and the modulation mode indicator includes a second number of bits, for indicating modulation mode of data channel in the physical resource block;

a first recovering unit 202, for recovering the quantified first common scale factor and the quantified second scale factor to the first common scale factor and the second common scale factor respectively;

a first transforming unit 203, for determining the bits representing the signal of the control channel after extracting the first common scale factor and the bits representing the signal of the data channel after extracting the second common scale factor in the multiple bits according to the control channel indicator, and transforming the bits representing the signal of the control channel after extracting the first common scale factor to the signal of the control channel after extracting the first common scale factor based on a third number of bits, wherein for each resource element in the physical resource pair occupied by the signal of is the control channel, the third number of bits represent the signal of the control channel in the resource element after extracting the first common scale factor;

a second transforming unit 204, for determining a fourth number of bits according to the modulation mode indicator, and transforming the bits representing the signal of the data channel after extracting the second common scale factor to the signal of the data channel after extracting the second common scale factor based on the fourth number of bits, wherein for each resource element in the physical resource pair occupied by the signal of the data channel, the fourth number of bits represent the signal of the data channel in the resource element after extracting the second common scale factor;

a second recovering unit 205, for recovering the signal of the control channel after extracting the first common scale factor by using the first common scale factor, and recovering the signal of the data channel after extracting the second common scale factor by using the second common scale factor; and

a processing unit 206, for processing the recovered signal of the control channel and the recovered signal of the data channel with IFFT.

Those skilled in the art shall appreciate that the foregoing embodiments are illustrative but not limiting. Different technical features appearing in different embodiments can be combined to advantage. Those skilled in the art can appreciate and make other variant embodiments of the disclosed embodiments upon review of the drawings, the description and the claims. In the claims, the term “comprising” will not preclude another device(s) or step(s); the definite article “a” or “an” will not preclude plural; and the terms “first”, “second”, etc., are intended to designate a name but not to suggest any specific order. Any reference numerals shall not be construed as limiting the claimed scope. Functions of a plurality of elements appearing in a claim can be performed by a single element. Some technical features appearing in is different dependent claims will not suggest that these technical features can not be combined to advantage.

1. A method, in a base band unit, of compressing a multi-carrier modulation signal in frequency domain, wherein the method is implemented in terms of a physical resource block pair, the method comprises:
setting a control channel position indicator including a first number of bits, for indicating symbol position occupied by the control channel in the physical resource block pair;
setting a modulation mode indicator including a second number of bits, for indicating modulation mode of data channel in the physical resource block;
extracting a first common scale factor of signals of the control channel in the physical resource block, and quantifying the first common scale factor;
extracting a second common scale factor of signals of the data channel in the physical resource block, and quantifying the second common scale factor;
configuring the control channel position indicator, the modulation mode indicator, the quantified first common scale factor and the quantified second common scale factor to a signal header;
for each resource element in the physical resource pair occupied by the signal of the control channel, representing the signal of the control channel in the resource element after extracting the first common scale factor with a third number of bits, and for each resource element in the physical resource pair occupied by the signal of the data channel, representing the signal of the data channel in the resource element after extracting the second scale factor with a fourth number of bits, according to the modulation mode of the data channel in the physical resource block pair;
encapsulating the signal header, the signal of the control channel in the resource element in the physical resource block pair processed, and the signal of the data channel in the resource element in the physical resource block pair processed into a compressed package; and
sending the compressed package to a remote radio head.

2. A method according to claim 1, wherein the first number of bits is 2 bits, when the number of resource blocks in the downlink bandwidth is greater than 10.

3. A method according to claim 1, wherein the first number of bits is 3 bits, when the number of resource blocks in the downlink bandwidth is less than or equal to 10.

4. A method according to claim 1, wherein the second number of bits is 2 bits, and the modulation mode of data channel includes QPSK, 16 QAM and 64 QAM.

5. A method according to claim 1, wherein, the first common scale factor and/or the second common scale factor are quantified by using full-resolution 16 bits.

6. A method according to claim 1, wherein:
for each resource element in the physical resource pair occupied by the signal of the control channel, representing the signal of the control channel in the resource element after extracting the first common scale factor with 2 bits; and
for each resource element in the physical resource pair occupied by the signal of the data channel, representing the signal of the data channel in the resource element after extracting the second scale factor with the number of bits which are occupied by a pair of I/Q signal in the modulation mode of the data channel in the physical resource block pair.

7. A method, in a remote radio head, of decompressing a multi-carrier modulation signal in frequency domain, wherein the method is implemented in terms of a physical resource block pair, the method comprises:
receiving a compressed package from a base band unit, wherein the compressed package includes a signal header and multiple bits, the multiple bits including bits representing the signal of the control channel after extracting a first common scale factor and bits representing the signal of the data channel after extracting a second common scale factor, and the signal header including a control channel position indicator, a modulation mode indicator, a quantified first common scale factor and a quantified second scale factor, wherein the control channel position indicator includes a first number of bits, for indicating symbol position occupied by the control channel in the physical resource block pair, and the modulation mode indicator includes a second number of bits, for indicating modulation mode of data channel in the physical resource block;
recovering the quantified first common scale factor and the quantified second scale factor to the first common scale factor and the second common scale factor respectively;
determining the bits representing the signal of the control channel after extracting the first common scale factor and the bits representing the signal of the data channel after extracting the second common scale factor in the multiple bits according to the control channel indicator, and transforming the bits representing the signal of the control channel after extracting the first common scale factor to the signal of the control channel after extracting the first common scale factor based on a third number of bits, wherein for each resource element in the physical resource pair occupied by the signal of the control channel, the third number of bits represent the signal of the control channel in the resource element after extracting the first common scale factor;
determining a fourth number of bits according to the modulation mode indicator, and transforming the bits representing the signal of the data channel after extracting the second common scale factor to the signal of the data channel after extracting the second common scale factor based on the fourth number of bits, wherein for each resource element in the physical resource pair occupied by the signal of the data channel, the fourth number of bits represent the signal of the data channel in the resource element after extracting the second common scale factor;
recovering the signal of the control channel after extracting the first common scale factor by using the first common scale factor, and recovering the signal of the data channel after extracting the second common scale factor by using the second common scale factor; and
processing the recovered signal of the control channel and the recovered signal of the data channel with IFFT.

8. A method according to claim 7, wherein the first number of bits is 2 bits, when the number of resource blocks in the downlink bandwidth is greater than 10.

9. A method according to claim 7, wherein the first number of bits is 3 bits, when the number of resource blocks in the downlink bandwidth is less than or equal to 10.

10. A method according to claim 7, wherein the second number of bits is 2 bits, and the modulation mode of data channel includes QPSK, 16 QAM and 64 QAM.

11. A method according to claim 7, wherein the quantified first common scale factor and/or the quantified second common scale factor are quantified by using full-resolution 16 bits.

12. A method according to claim 7, wherein the third number of bits is 2 bits.

13. A method according to claim 7, wherein the fourth number of bits is the number of bits which are occupied by a pair of I/Q signal in the modulation mode of the data channel.

14. An apparatus, in a base band unit, of compressing a multi-carrier modulation signal in frequency domain, the apparatus comprising:
a first setting unit, for setting a control channel position indicator including a first number of bits, for indicating symbol position occupied by the control channel in the physical resource block pair;
a second setting unit, for setting a modulation mode indicator including a second number of bits, for indicating modulation mode of data channel in the physical resource block;
a first extracting and quantifying unit, for extracting a first common scale factor of signals of the control channel in the physical resource block, and quantifying the first common scale factor;
a second extracting and quantifying unit, for extracting a second common scale factor of signals of the data channel in the physical resource block, and quantifying the second common scale factor;
a configuring unit, for configuring the control channel position indicator, the modulation mode indicator, the quantified first common scale factor and the quantified second common scale factor to a signal header;
a representing unit, for each resource element in the physical resource pair occupied by the signal of the control channel, representing the signal of the control channel in the resource element after extracting the first common scale factor with a third number of bits, and for each resource element in the physical resource pair occupied by the signal of the data channel, representing the signal of the data channel in the resource element after extracting the second scale factor with a fourth number of bits, according to the modulation mode of the data channel in the physical resource block pair;
an encapsulating unit, for encapsulating the signal header, the signal of the control channel in the resource element in the physical resource block pair processed by the representing unit, and the signal of the data channel in the resource element in the physical resource block pair processed by the representing unit into a compressed package; and
a sending unit, for sending the compressed package to a remote radio head.

15. An apparatus, in a remote radio head, of decompressing a multi-carrier modulation signal in frequency domain, the apparatus comprising:
a receiving unit, for receiving a compressed package from a base band unit, wherein the compressed package includes a signal header and multiple bits, the multiple bits including bits representing the signal of the control channel after extracting a first common scale factor and bits representing the signal of the data channel after extracting a second common scale factor, and the signal header including a control channel position indicator, a modulation mode indicator, a quantified first common scale factor and a quantified second scale factor, wherein the control channel position indicator includes a first number of bits, for indicating symbol position occupied by the control channel in the physical resource block pair, and the modulation mode indicator includes a second number of bits, for indicating modulation mode of data channel in the physical resource block;
a first recovering unit, for recovering the quantified first common scale factor and the quantified second scale factor to the first common scale factor and the second common scale factor respectively;
a first transforming unit, for determining the bits representing the signal of the control channel after extracting the first common scale factor and the bits representing the signal of the data channel after extracting the second common scale factor in the multiple bits according to the control channel indicator, and transforming the bits representing the signal of the control channel after extracting the first common scale factor to the signal of the control channel after extracting the first common scale factor based on a third number of bits, wherein for each resource element in the physical resource pair occupied by the signal of the control channel, the third number of bits represent the signal of the control channel in the resource element after extracting the first common scale factor;
a second transforming unit, for determining a fourth number of bits according to the modulation mode indicator, and transforming the bits representing the signal of the data channel after extracting the second common scale factor to the signal of the data channel after extracting the second common scale factor based on the fourth number of bits, wherein for each resource element in the physical resource pair occupied by the signal of the data channel, the fourth number of bits represent the signal of the data channel in the resource element after extracting the second common scale factor;
a second recovering unit, for recovering the signal of the control channel after extracting the first common scale factor by using the first common scale factor, and recovering the signal of the data channel after extracting the second common scale factor by using the second common scale factor; and
a processing unit, for processing the recovered signal of the control channel and the recovered signal of the data channel with IFFT.
